(19) United States
(12) Patent Application Publication
(10) Pub. No.: US 2022/0036213 A1
(43) Pub. Date: Feb. 3, 2022

(54) COMBINING RULES-BASED KNOWLEDGE ENGINEERING WITH MACHINE LEARNING PREDICTION

(71) Applicant: Intuit Inc., Mountain View, CA (US)

(72) Inventors: Kevin Michael Furbish, Tampa, FL (US); Kevin M. McCluskey, Carlsbad, CA (US); Peter E. Lubczynski, San Diego, CA (US)

(73) Assignee: Intuit Inc., Mountain View, CA (US)

(21) Appl. No.: 16/943,481

(22) Filed: Jul. 30, 2020

(51) Int. Cl. G06N 5/04; G06N 20/00

(52) U.S. Cl. CPC G06N 5/04; G06N 20/00

(57) ABSTRACT

Systems and methods for predicting one or more field values using machine learning in a knowledge engineering (KE) data model are disclosed. An example method may include identifying a first field in the KE data model which lacks a value and for which one or more machine learning models are defined, the first field being associated with one or more dependent field, determining that each dependent field of the first field has a corresponding value in the KE data model, executing each of the one or more machine learning models to predict one or more values for the first field, selecting one of the one or more predicted values as the representative value of the first field, identifying one or more further fields in the KE data model for which the first field is a dependent field, none of the one or more further fields defining any machine learning models, and calculating values for one or more further fields based at least in part on the representative value of the first field.

### TECHNICAL FIELD

This disclosure relates generally to methods for operating rules-based knowledge engineering (KE) applications, and specifically to incorporating machine learning into such KE applications.

### DESCRIPTION OF RELATED ART

Increasingly, artificial intelligence (AI) systems have been applied to simplify data entry, categorization, and related analytics using rule-based systems. An example of such a rule-based system is a knowledge engineering (KE) data model. For example, a KE data model may include multiple fields for storing a variety of related information items. Values for some fields may be imported, for example, from an external data source. A user may be prompted to enter values for some other fields. Further, values of empty fields may be calculated based on values of one or more other fields using a set of rules. Such rule-based systems may be useful for document understanding, business management and decision making, cash flow forecasting, tax, and financial planning, determining eligibility for governmental or other benefits, and a variety of other applications.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for predicting values of one or more fields in a knowledge engineering (KE) data model associated with one or more machine learning models. An example method may include identifying a first field in the KE data model which lacks a value and for which one or more machine learning models are defined, the first field being associated with one or more dependent fields, determining that each of the one or more dependent fields has a respective value in the KE data model, executing each of the one or more machine learning models to predict one or more values for the first field, selecting one of the one or more predicted values as a representative value of the first field, identifying one or more further fields in the KE data model for which the first field is a dependent field, none of the one or more further fields defining any machine learning models, and calculating values each of the one or more further fields based at least in part on the representative value of the first field.

In some aspects, the representative value of the first field is the predicted value associated with a highest priority machine learning model of the one or more machine learning models. In some aspects, the representative value of the first field is selected based at least in part on respective confidence levels associated with each of the one or more predicted values. In some aspects, the representative value of the first field is selected based at least in part on a prioritization list associated with the one or more machine learning models and on respective confidence levels associated with each of the one or more predicted values. In some aspects a predicted value of the first field may be discarded when a corresponding confidence level of the predicted values is less than a threshold confidence levels.

In some aspects selecting the one of the one or more predicted values as the representative value of the first field includes adding the selected one of the predicted values and metadata associated with the selected one of the predicted values to the KE data model. In some aspects, the metadata may include at least an indication that the value of the first field was predicted and a confidence level associated with the selected one of the predicted values.

In some aspects, the method may further include identifying one or more incomplete fields of the KE data model for which no value is provided and prompting a user to enter a value for a highest priority field of the one or more incomplete fields. In some aspects, after prompting the user to enter the value for the highest priority field of the one or more incomplete fields, the method may further include identifying a second field in the KE data model which lacks a value and for which one or more machine learning models are defined, determining that each dependent field of the second field has a respective value in the KE data model, executing each of the one or more machine learning models to predict one or more values of the second field, and selecting one of the one or more predicted values as the representative value of the second field.

In some aspects, the KE data model comprises a first plurality of fields having values to be entered by a user, a second plurality of fields to be calculated based on values of other fields in the KE data model, and a third plurality of fields to be predicted using the one or more machine learning models.

Another innovative aspect of the subject matter described in this disclosure can be implemented in a computing device associated with one or more machine learning models. An example computing device may include one or more processors and a memory storing instructions for execution by the one or more processors. Execution of the instructions causes the computing device to perform operations including identifying a first field in a knowledge engineering (KE) data model which lacks a value and for which one or more machine learning models are defined, the first field being associated with one or more dependent fields, determining that each of the one or more dependent fields has a respective value in the KE data model, executing each of the one or more machine learning models to predict one or more values for the first field, selecting one of the one or more predicted values as a representative value of the first field, identifying one or more further fields in the KE data model for which the first field is a dependent field, none of the one or more further fields defining any machine learning models, and calculating values each of the one or more further fields based at least in part on the representative value of the first field.

In some aspects, the representative value of the first field is the predicted value associated with a highest priority machine learning model of the one or more machine learning models. In some aspects, the representative value of the first field is selected based at least in part on respective confidence levels associated with each of the one or more predicted values. In some aspects, the representative value of the first field is selected based at least in part on a prioritization list associated with the one or more machine learning models and on respective confidence levels associated with each of the one or more predicted values. In some aspects a predicted value of the first field may be discarded when a corresponding confidence level of the predicted values is less than a threshold confidence levels.

In some aspects selecting the one of the one or more predicted values as the representative value of the first field includes adding the selected one of the predicted values and metadata associated with the selected one of the predicted values to the KE data model. In some aspects, the metadata may include at least an indication that the value of the first field was predicted and a confidence level associated with the selected one of the predicted values.

In some aspects, the method may further include identifying one or more incomplete fields of the KE data model for which no value is provided and prompting a user to enter a value for a highest priority field of the one or more incomplete fields. In some aspects, after prompting the user to enter the value for the highest priority field of the one or more incomplete fields, the method may further include identifying a second field in the KE data model which lacks a value and for which one or more machine learning models are defined, determining that each dependent field of the second field has a respective value in the KE data model, executing each of the one or more machine learning models to predict one or more values of the second field, and selecting one of the one or more predicted values as the representative value of the second field.

Another innovative aspect of the subject matter described in this disclosure can be implemented in a non-transitory computer-readable medium. The non-transitory computer-readable medium stores instructions that, when executed by one or more processors of a computing device, cause the computing device to predict one or more field values using machine learning in a knowledge engineering (KE) data model by performing operations including identifying a first field in the KE data model which lacks a value and for which one or more machine learning models are defined, the first field being associated with one or more dependent fields, determining that each of the one or more dependent fields has a respective value in the KE data model, executing each of the one or more machine learning models to predict one or more values for the first field, selecting one of the one or more predicted values as a representative value of the first field, identifying one or more further fields in the KE data model for which the first field is a dependent field, none of the one or more further fields defining any machine learning models, and calculating values each of the one or more further fields based at least in part on the representative value of the first field.

### BRIEF DESCRIPTION OF THE DRAWINGS

The example implementations are illustrated by way of example and are not intended to be limited by the figures of the accompanying drawings. Like numbers reference like elements throughout the drawings and specification. Note that the relative dimensions of the following figures may not be drawn to scale.

FIG. 1 shows a machine learning (ML) augmented KE system, according to some implementations.

FIG. 2A shows a high-level overview of an example process flow that may be employed by the ML augmented KE system of FIG. 1.

FIG. 2B shows a high-level overview of an example process flow that may be employed by the ML augmented KE system of FIG. 1.

FIG. 3 shows an illustrative flow chart depicting an example operation for predicting one or more field values using machine learning in a knowledge engineering (KE) data model, according to some implementations.

FIG. 4 shows an illustrative flow chart depicting an example operation for predicting one or more field values using machine learning in a knowledge engineering (KE) data model, according to some implementations.

FIG. 5 shows an illustrative flow chart depicting an example operation for predicting one or more field values using machine learning in a knowledge engineering (KE) data model, according to some implementations.

### DETAILED DESCRIPTION

Implementations of the subject matter described in this disclosure may be used to define one or multiple machine learning models for predicting fields in a rule-based knowledge engineering (KE) data model. Predicting values of fields in such a data model using one or more machine learning models may expand and improve the capabilities and broaden the range of fields which may be included in such data models. As described above, conventional rule-based KE data models may allow for fields and outcomes to be calculated based on the values of other fields in the data model—provided that a given field is calculated as a sum, difference, product and so on of values of other fields. However, predicting values of some fields using machine learning models may incorporate insights beyond mere calculations. Values present in first fields of the data model may not dictate a value of a second field but may indicate likely values of that second field with varying degrees of confidence. Further, multiple machine learning models may be defined for a single field. Different machine learning models may be able to predict the field's value at differing levels of accuracy and requiring different numbers of dependent fields (fields whose values are required to predict or calculate a value of another field). Resolution rules may be used to determine which predicted value of a field is to be entered when multiple machine learning models are defined for the field. Predicting and calculating values of fields in an example KE data model incorporating both rule-based calculation and machine learning prediction of fields may be performed in a pre-processing mode or alternatively in an on-demand mode, as discussed further below.

Various implementations of the subject matter disclosed herein provide one or more technical solutions to the technical problem of expanding the functionality of rule-based KE data models by incorporating machine learning predictions. More specifically, various aspects of the present disclosure provide a unique computing solution to a unique computing problem that did not exist prior to electronic or online KE systems that can calculate field values and outcomes based on machine learning predictions. As such, implementations of the subject matter disclosed herein are not an abstract idea such as organizing human activity or a mental process that can be performed in the human mind.

Moreover, various aspects of the present disclosure effect an improvement in the technical field of expanding the functionality of rule-based KE data models by incorporating machine learning. The use of one or multiple machine learning models for predicting values of one or more fields of the KE data model, as well as their incorporation and use within a rule-based KE data model, cannot be performed in the human mind, much less using pen and paper. In addition, implementations of the subject matter disclosed herein do far more than merely create contractual relationships, hedge risks, mitigate settlement risks, and the like, and therefore cannot be considered a fundamental economic practice.

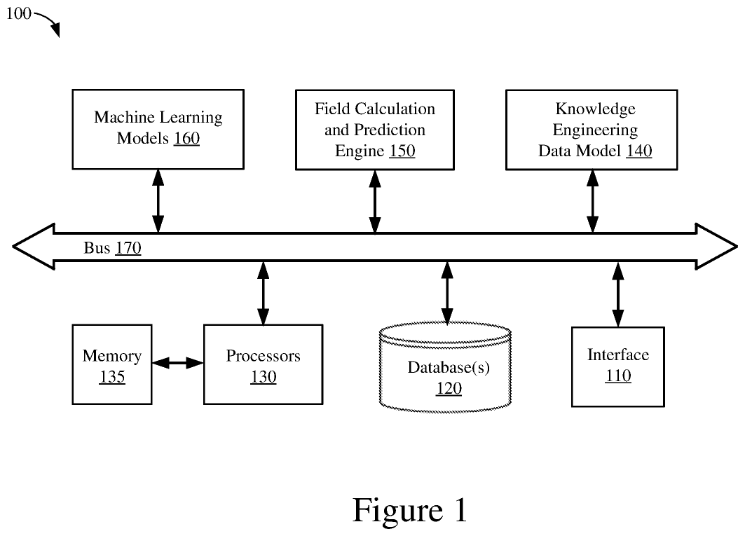

FIG. 1 shows a machine learning (ML) augmented KE system 100, according to some implementations. Various aspects of the ML augmented KE system 100 disclosed herein may be applicable for calculating and predicting values of fields in a variety of applications, such as automating tasks, automating data entry and categorizations, and data analytics. Such functionality may be useful for document understanding, cash flow forecasting, loan application and compliance requirements, managing business and financial tasks, determining eligibility for and regulatory compliance with governmental or charitable benefits, and a variety of other subject areas.

The ML augmented KE system 100 is shown to include an input/output (I/O) interface 110, a database 120, one or more data processors 130, a memory 135 coupled to the data processors 130, KE data models 140, a filed calculation and prediction engine 150, and machine learning models 160. In some implementations, the various components of the ML augmented KE system 100 may be interconnected by at least a data bus 170, as depicted in the example of FIG. 1. In other implementations, the various components of the ML augmented KE system 100 may be interconnected using other suitable signal routing resources.

The interface 110 may include a screen, an input device, and other suitable elements that allow a user to provide information to the ML augmented KE system 100 and/or to retrieve information from the ML augmented KE system 100. Example information that can be provided to the ML augmented KE system 100 may include one or more sets of training data for training the machine learning models 160, one or more values associated with a previous version the KE data model 140, such as one or more historical values previously entered into one or more fields by a user, or the like. Example information that can be retrieved from the ML augmented KE system 100 may include user-entered values, KE calculated values, and ML predicted values associated with one or more fields of the KE data model 140, one or more documents based on such fields, one or more outcomes of the KE data models 140, and the like.

The database 120, which may represent any suitable number of databases, may store any suitable information pertaining to each of a plurality of accounts registered with one or more users of the ML augmented KE system 100. For example, the information may include training data for the machine learning models 160, may include account information for one or more users of the ML augmented KE system 100 (such as phone numbers, email addresses, physical mailing address, SSNs, and so on), and so on. In some implementations, the database 120 may be a relational database capable of presenting the information as data sets to a user in tabular form and capable of manipulating the data sets using relational operators. In some aspects, the database 120 may use Structured Query Language (SQL) for querying and maintaining the database 120.

The data processors 130, which may be used for general data processing operations (such as manipulating the data sets stored in the database 120), may be one or more suitable processors capable of executing scripts or instructions of one or more software programs stored in the ML augmented KE system 100 (such as within the memory 135). The data processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may be implemented as a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the data processors 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The KE data models 140 may be used to represent a plurality of fields and outcomes of one or more KE data models. For each field, one or more rules may define are defined for calculating a value of the field, may define rules for use of one or more machine learning models to predict a value of the field, or may indicate that a user is to enter a value of the field. For example, during authorship of the KE data models 140, the field may be defined to include the rules to be used for calculating the value of the field, or the machine learning models and resolution rules to be used for predicting the value of the field, or may indicate that the user is to enter the value of the field. Such information may be stored in logic associated with the KE data models, such as in rules stored in a KE platform, as a part of KE data models 140 or stored in the database 120. Each field may also indicate one or more dependent fields. Dependent fields of a given field are other fields of the KE data models 140 which are required for calculating or predicting a value of the given field. When a given field defines rules for calculating the value of the given field, the rules may indicate how the value of the given field may be calculated based on the corresponding dependent fields. As discussed further below, when a given field defines more than one machine learning model for predicting the given field's value, the given field may further indicate resolution rules for determining which of the predictions is to be used as the value of the given field. The KE data models 140 may also represent one or more outcomes associated with the one or more KE data models. For example, the outcomes may represent relevant conclusions which may be drawn from the values of the fields. For example, when a KE data model includes a plurality of fields and outcomes relating to tax filings, the outcomes may indicate a filer's eligibility or ineligibility for various deductions, whether or not a filer may be claimed as a dependent, and so on. Some outcomes may be “final outcomes.” Final outcomes may represent a primary conclusion of the KE data model. For example, when a KE data model includes a plurality of fields and outcomes relating to a particular government program, such as a small business relief program, a final outcome may indicate a conclusion that a user is eligible or ineligible for a benefit.

The field calculation and prediction engine 150 may be used to calculate and predict values of fields and outcomes of the KE data models 140 based on the rules for calculating values of fields and outcomes or the rules defined for predicting values of fields using the machine learning models associated with those fields. For example, the field calculation and prediction engine 150 may execute one or more of the machine learning models 160 to predict a value of a field associated with the KE data models 140 and may select one of the predicted values based on resolution rules associated with the predicted field. The field calculation and prediction engine 150 may also determine completeness of a KE data model of the KE data models 140 by determining which fields lack a value, and which of the fields lacking a value are required for determining a final outcome of the KE data model. The field calculation and prediction engine 150 may also determine a highest priority field in a KE data model which is lacking a value and prompt a user to enter a value for the determined highest-priority field, as further discussed below.

The machine learning models 160 may include any number of machine learning models that can be used to predict values of fields of the KE data models 140. A machine learning model can take the form of an extensible data structure that can be used to represent sets of words or phrases and/or can be used to represent sets of attributes or features. The machine learning models may be seeded with historical data indicating relationships between field values and values of dependent fields for one or more historical users. In some implementations, the machine learning models 160 may include deep neural networks (DNNs), which may have any suitable architecture, such as a feedforward architecture or a recurrent architecture.

The particular architecture of the ML augmented KE system 100 shown in FIG. 1 is but one example of a variety of different architectures within which aspects of the present disclosure may be implemented. For example, in other implementations, the ML augmented KE system 100 may not include KE data models 140, the functions of which may be implemented by the processors 130 executing corresponding instructions or scripts stored in the memory 135. In some other implementations, the functions of the field calculation and prediction engine 150 may be performed by the processors 130 executing corresponding instructions or scripts stored in the memory 135. Similarly, the functions of the machine learning models 160 may be performed by the processors 130 executing corresponding instructions or scripts stored in the memory 135.

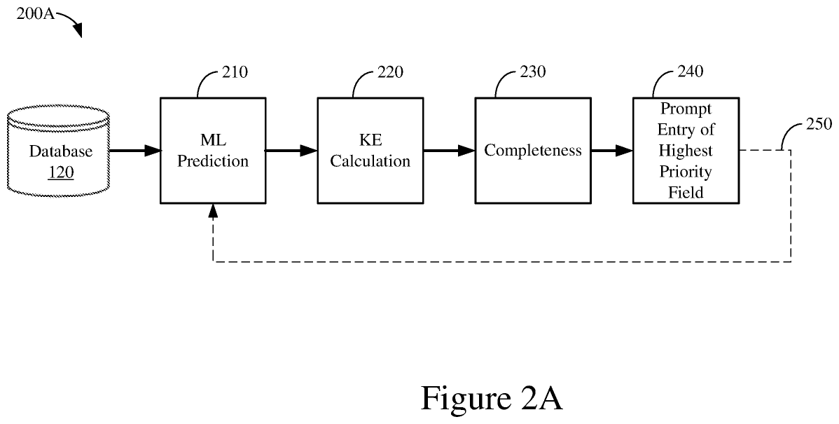

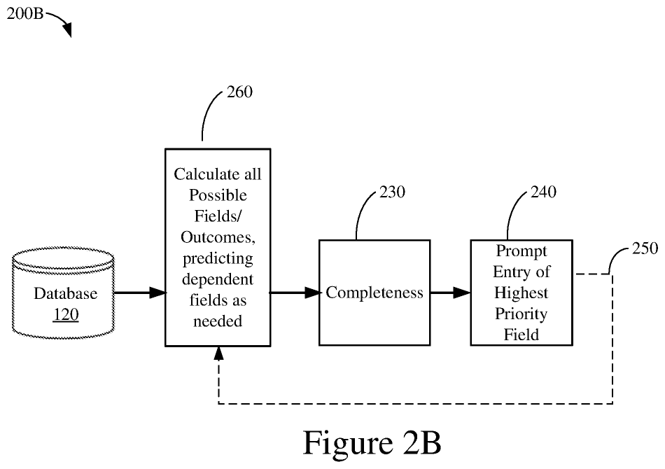

FIG. 2A shows a high-level overview of an example process flow 200A that may be employed by the ML augmented KE system 100 of FIG. 1. As discussed further below, the example process flow may be a “pre-processing” flow whereby the values of one or more fields are predicted first, and subsequently calculated using the rules of the KE data model. In block 210, ML prediction is performed for all possible fields of the KE data model, that is, for all fields for which one or more ML models are defined, and for which all dependent fields have a value. For example, the details of the one or more ML models, such as model identification, training data, indications of the corresponding dependent fields, resolution rules, and the like, may be retrieved from the database 120. When more than one ML model is defined for a field, each of the defined ML models is executed to predict a value of the field. As discussed further below, resolution rules defined for the field may be applied to select one of the predicted values as the value of that field. The selected value may then be added to the KE data model. In some aspects, metadata may also be added to the KE data model with the selected value. Example metadata may include, but is not limited to, metadata indicating that the field was predicted, and metadata indicating a confidence level of the prediction. At block 220, values may be calculated for outcomes and fields in the KE data model for which no ML models are defined, and for which all dependent fields have a value. At block 230, a completeness determination is performed. The completeness determination may identify required fields of the KE data model which still lack a value. Required fields may be those fields of the KE data model which require a value in order to calculate one or more final outcomes of the KE data model. If no required fields are lacking a value, the process flow 200A may end. In other words, if no final outcomes of the KE data model are missing a value, the process flow 200A may end. Otherwise, the process flow 200A proceeds to block 240, where a user is prompted to enter a value for a highest priority required field identified during the completeness determination. After receiving a value of the highest priority required field, the process flow 200A may return (250) to block 210. Predicting values of one or more fields in a first iteration of block 210, calculating values of one or more fields during a first iteration of block 220, or receiving a value of a field during a first iteration of block 240 may allow more fields to be predicted or calculated during a second iteration of blocks 210 and 220. For example, the fields whose values are predicted, calculated, or entered by a user during a first iteration of blocks 210, 220, and 240 may be dependent fields of other fields of the KE data model. As such, the presence of values in these dependent fields may allow more fields to be predicted or calculated during the second iteration.

FIG. 2B shows a high-level overview of an example process flow 200B that may be employed by the ML augmented KE system 100 of FIG. 1. As discussed further below, the example process flow may be an “on-demand” flow wherein fields and outcomes of the KE data model are calculated on-demand. For example, the process flow 200B may be performed in response to receiving a user request to calculate values of all possible fields and outcomes. In block 260, values of all possible fields and outcomes for the KE data model are calculated. As discussed further below, when a value of a dependent field is required for calculating a value for a field or outcome, the value of that dependent field is used for the calculation if available. If the dependent field does not have a value, but one or more ML models are defined for the dependent field, then each of the defined ML models is executed to predict a value for the dependent field, and resolution rules are applied to select one of the predicted values, such as described with reference to block 210 of FIG. 2A. The selected value may then be added to the KE data model. In some aspects, metadata may also be added to the KE data model, with the selected value. Example metadata may include, but is not limited to, metadata indicating that the value of the field was predicted and metadata indicating a confidence level of the prediction. At block 230, a completeness determination is performed. The completeness determination may identify required fields of the KE data model which still lack a value. Required fields may be those fields of the KE data model which require a value in order to calculate one or more final outcomes of the KE data model. If no required fields are lacking a value, the process flow 200B may end. In other words, if no final outcomes of the KE data model are missing a value, the process flow 200B may end. Otherwise, the process flow 200B proceeds to block 240, where a user is prompted to enter a value for a highest priority required field identified during the completeness determination. After receiving a value of the highest priority required field, the process flow 200B may return (250) to block 260. As described above with reference to process flow 200A, repeating blocks 260 and 240 may allow more fields to be predicted or calculated during a second iteration of blocks 260 and 240.

As discussed above, KE data models may be used in a wide variety of applications, such as document understanding, cash flow forecasting, loan application and compliance requirements, managing business and financial tasks, determining eligibility for and regulatory compliance with governmental or charitable benefits, and a variety of other subject areas. For some examples, KE data models may be used for determining eligibility for governmental loan programs, such as small business loans under the Coronavirus Aid, Relief, and Economic Security (CARES) Act. However, while conventional KE data models may calculate fields and outputs based on the values of dependent fields, they cannot leverage machine learning to predict values of fields or incorporate those predicted values into other calculations. Incorporating ML models to predict values of fields in KE data models may allow data models to not only calculate values of fields but to incorporate broader insights from training data. For example, such training data may include field values for other users and may include insights into how fields may relate, probabilistically, and into confidence levels relating to such relations. Thus, ML prediction for some fields of a KE data model may allow for the KE data model to benefit from these insights, and to predict values of fields with varying degrees of confidence, when strict calculation of a field is not possible. For example, in a KE data model relating to tax return preparation, an indication that an income level above a threshold level may allow the KE data model to predict an outcome that a specific tax deduction may be appropriate, with a corresponding degree of confidence, before other field values confirm whether or not the deduction is appropriate. A user may, for example, then be directed to enter data which may confirm whether or not the deduction applies.

Aspects of the present disclosure allow for the definition of one or more ML models for fields of a KE data model, enabling values of such fields to be predicted. The one or more ML models may be defined for fields of the KE data model, for example, during authorship of the KE data model. The dependent fields required for the prediction may also be defined during authorship of the KE data model. The ML models may include supervised ML models which have been previously trained, unsupervised ML models which require no additional training, ML models which have been trained suing automated means, such as through applications like Amazon Sagemaker Autopilot. Further, in some aspects the ML models may be trained on historical data from other users, such as data including historical values of the field to be predicted and historical values of the dependent fields of the ML model.

As previously mentioned, multiple ML models may be defined for the same field. Defining multiple ML models for a single field may be beneficial, for example, because different ML models may have differing levels of fidelity and differing dependent field requirements. For example, one ML model may require only a small number of dependent fields but may predict only a rough estimate of a field's value, while another ML model may require a larger number of dependent fields but may generate a more accurate predicted value of the field. Where multiple ML models are defined for a field, resolution rules may also be included, for example during authorship, for determining which of multiple predicted values should be added to the KE data model as the value of the field. For example, each ML model may have a corresponding confidence level associated with a predicted value, and the resolution rules may be based at least in part on such confidence levels.

In some aspects, the resolution rules may be used to select among multiple predicted values based on which prediction is associated with the highest confidence level. In some implementations a minimum acceptable confidence level may be specified, for example, during authorship of the KE data model. The minimum acceptable confidence level may specify a confidence level below which a predicted value is not to be used. For example, when an ML model predicts a value of a field to be below the minimum acceptable confidence level, this predicted value is discarded and not to be used as the value of the field.

In some other implementations, the resolution rules may select among multiple predicted values based on an ML model prioritization list, such that specified ML models are always preferred over other ML models. For example, if ML model 1, ML model 2, and ML model 3 are defined for a given field, such a prioritization list may specify that ML model 1 takes first priority, ML model 2 takes second priority, and ML model 3 takes third priority. If the dependent fields for ML model 1 are unavailable, but those for ML model 2 and ML model 3 are available, then ML model 2 and ML model 3 may be used to predict the value of the field. Because ML model 2 has higher priority than ML model 3, the value predicted by ML model 2 may be added to the KE data model as the value of the field.

In some other implementations, more complicated resolution rules may be defined. In some aspects, such rules may combine confidence levels with ML model prioritization. For example, consider 3 ML models defined for a field: a high accuracy ML model 1, a medium accuracy ML model 2, and a low accuracy ML model 3. One set of resolution rules could specify that if ML model 1's prediction is at least 90% confident it should always be used, that if ML model 2's prediction is 75% confident then it should be used unless ML model 1 is at least 60% confident, and that otherwise ML model 3's prediction may be used if it has a confidence level of at least 75%. Many such resolution rules are possible, depending on the specific ML models used.

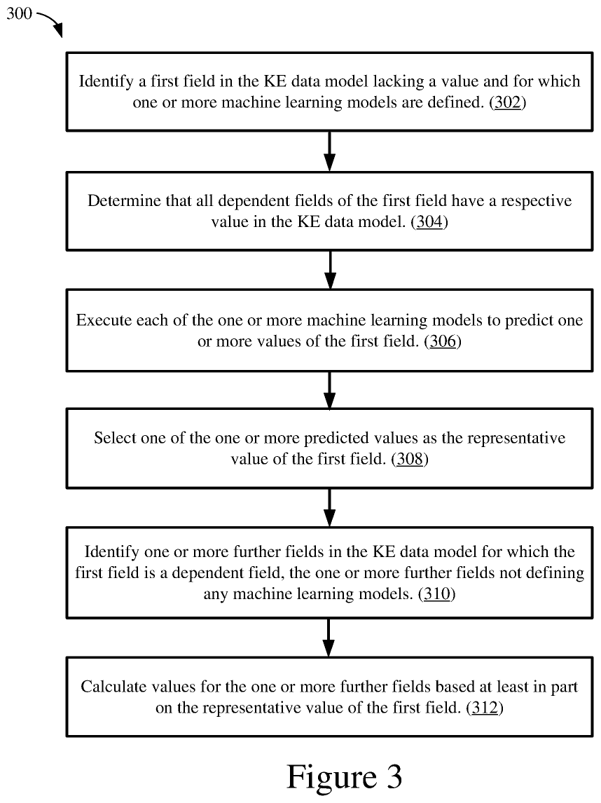

FIG. 3 shows an illustrative flow chart depicting an example operation 300 for predicting one or more field values using machine learning in a knowledge engineering (KE) data model, according to some implementations. The example operation 300 may be performed by one or more processors of a computing device associated with the KE data model. In some implementations, the example operation 300 may be performed using the ML augmented KE system 100 of FIG. 1. It is to be understood that the example operation 300 may be performed by any suitable systems, computers, or servers.

At block 302, the ML augmented KE system 100 identifies a first field in the KE data model lacking a value and for which one or more machine learning models are defined. At block 304, the ML augmented KE system 100 determines that each dependent field of the first field has a respective value in the KE data model. At block 306, the ML augmented KE system 100 executes each of the one or more machine learning models to predict one or more values of the first field. At block 308, the ML augmented KE system 100 selects one of the one or more predicted values as the representative value of the first field. At block 310, the ML augmented KE system 100 identifies one or more further fields in the KE data model for which the first field is a dependent field, the one or more further fields not defining any machine learning models. At block 312, the ML augmented KE system 100 calculates values for each of the one or more further fields based at least in part on the representative value of the first field.

In some aspects, the representative value of the first field selected in block 308 is the predicted value associated with a highest priority machine learning model of the one or more machine learning models. In some other aspects, the representative value of the first field is selected based at least in part on respective confidence level associated with each of the one or more predicted values. In further aspects, the representative value of the first field is selected based on a prioritization list associated with the one or more machine learning models and on respective confidence levels associated with each of the one or more predicted values. In some aspects, a predicted value is discarded with its corresponding confidence level is less than a threshold confidence level. In some aspects, selecting one or more of the predicted values in block 308 further includes adding the representative value and metadata associated with the representative value to the KE data model. The metadata may include an indication that the field's value was predicted, and a confidence level associated with the representative value.

In some aspects, the operation 300 may further include identifying one or more incomplete fields of the KE data model for which no value is provided and prompting a user to enter a value for a highest priority field of the one or more incomplete fields. In some aspects, after prompting the user to enter a value for the highest priority field, the operation 300 may further include identifying a second field in the KE data model which lacks a value and for which one or more machine learning models are defined, determining that each dependent field of the second field has a corresponding value in the KE data model, executing each of the one or more machine learning models to predict one or more of the second field, and selecting one of the one or more predicted values as the representative value of the second field.

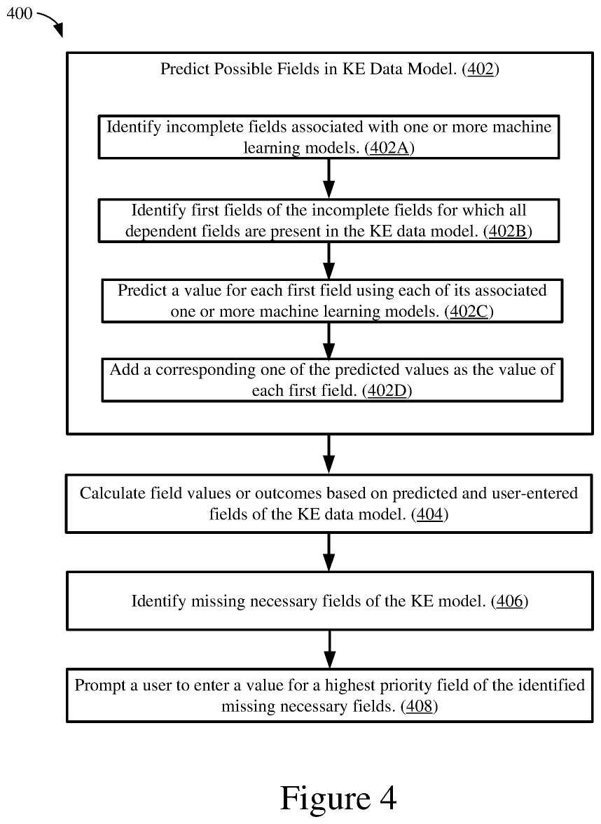

FIG. 4 shows an illustrative flow chart depicting an example operation 400 for predicting one or more field values using machine learning in a knowledge engineering (KE) data model, according to some implementations. The example operation 400 may be performed by one or more processors of a computing device associated with the KE data model. In some implementations, the example operation 400 may be performed using the ML augmented KE system 100 of FIG. 1. It is to be understood that the example operation 400 may be performed by any suitable systems, computers, or servers. The example operation 400 may be an example of the pre-processing flow, such as the process flow 200A of FIG. 2A.

At block 402, the ML augmented KE system 100 may predict all possible fields in the KE data model. At block 402A, the ML augmented KE system 100 may identify incomplete fields associated with one or more ML models. At block 402B, the ML augmented KE system 100 may identify first fields of the incomplete fields for which all dependent fields are present in the KE data model. At block 402C the ML augmented KE system 100 may predict a value for each first field using each of its associated one or more ML models. At block 402D, the ML augmented KE system 100 may add a corresponding one of the predicted values as the value of each first field. After predicting possible fields in the KE data model in block 402, at block 404 the ML augmented KE system 100 may calculate field values or outcomes based on predicted and user-entered fields of the KE data model. At block 406, the ML augmented KE system 100 may identify missing necessary fields of the KE data model, the missing necessary fields lacking a value and required for determining one or more final outcomes of the KE data model. At block 408, the ML augmented KE system 100 may prompt a user to enter a value for a highest priority field of the identified missing necessary fields.

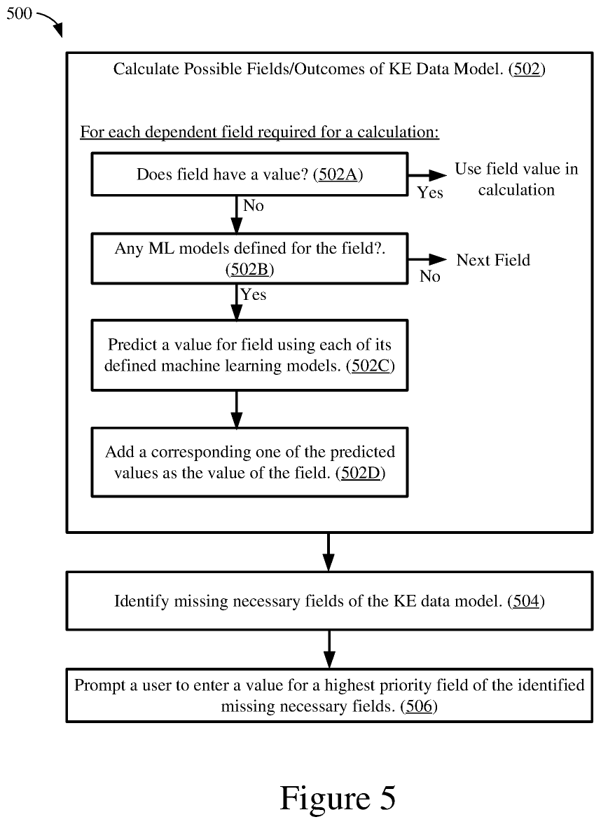

FIG. 5 shows an illustrative flow chart depicting an example operation 500 for predicting one or more field values using machine learning in a knowledge engineering (KE) data model, according to some implementations. The example operation 500 may be performed by one or more processors of a computing device associated with the KE data model. In some implementations, the example operation 500 may be performed using the ML augmented KE system 100 of FIG. 1. It is to be understood that the example operation 500 may be performed by any suitable systems, computers, or servers. The example operation 500 may be an example of the on-demand flow, such as the process flow 200B of FIG. 2B.

At block 502, the ML augmented KE system 100 may calculate all possible fields and outcomes of the KE data model. For each field required for a calculation, the ML augmented KE system 100 may determine (502A) whether or not the field has a value. If the field has a value, that value is used in the calculation. If the field has no value, the ML augmented KE system 100 may determine (502B) whether or not any ML models are defined for the field. If no ML models are defined for the field, the calculation cannot be performed yet, and the ML augmented KE system 100 proceeds to the next calculation. If one or more ML models are defined for the field, the ML augmented KE system 100 may predict (502C) a value for the field using each of the defined machine learning models, provided that all dependent fields required by the defined ML models are present. If all dependent fields required by the one or more ML models are not present, then the field may not be predicted yet, and consequently the calculation may not be performed yet, and the ML augmented KE system 100 proceeds to the next calculation. After predicting values of the field using each of the defined ML models, the ML augmented KE system 100 adds (502D) one of the predicted values to the KE data model as the value of the field. As discussed above, various resolution rules may determine which of the predicted values is added as the value of the field. After performing all possible calculations of field and outcomes, at block 504 the ML augmented KE system 100 may identify missing necessary fields of the KE data model, the missing necessary fields lacking a value and required for determining one or more final outcomes of the KE data model. At block 506, the ML augmented KE system 100 may prompt a user to enter a value for a highest priority field of the identified missing necessary fields.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method of predicting values for one or more fields of a knowledge engineering (KE) data model, the method performed by one or more processors of a computing device associated with one or more machine learning models and comprising:
identifying a first field in the KE data model which lacks a value and for which one or more machine learning models are defined, the first field being associated with one or more dependent fields;
determining that each of the one or more dependent fields has a respective value in the KE data model;
executing each of the one or more machine learning models to predict one or more values for the first field;
selecting one of the one or more predicted values as a representative value of the first field;
identifying one or more further fields in the KE data model for which the first field is a dependent field, none of the one or more further fields defining any machine learning models; and
calculating values for each of the one or more further fields based at least in part on the representative value of the first field.

2. The method of claim 1, wherein the representative value is the predicted value associated with a highest priority machine learning model of the one or more machine learning models.

3. The method of claim 1, wherein the representative value of the first field is selected based at least in part on respective confidence levels associated with each of the one or more predicted values.

4. The method of claim 1, wherein the representative value of the first field is selected based at least in part on a prioritization list associated with the one or more machine learning models and on respective confidence levels associated with each of the one or more predicted values.

5. The method of claim 1, wherein selecting one of the one or more predicted values as the representative value of the first field comprises discarding a predicted value when a corresponding confidence level of the predicted value is less than a threshold confidence level.

6. The method of claim 1, wherein selecting one of the one or more predicted values as the representative value of the first field further comprises adding the selected one of the predicted values and metadata associated with the selected one of the predicted values to the KE data model.

7. The method of claim 6, wherein the metadata indicates at least an indication that the value of the first field was predicted and a confidence level associated with the selected one of the predicted values.

8. The method of claim 1, further comprising identifying one or more incomplete fields of the KE data model for which no value is provided and prompting a user to enter a value for a highest priority field of the one or more incomplete fields.

9. The method of claim 8, further comprising, after prompting the user to enter the value for the highest priority field of the determined one or more incomplete fields:
identifying a second field in the KE data model which lacks a value and for which one or more machine learning models are defined;
determining that each of the dependent fields of the second field has a respective value in the KE data model;
executing each of the one or more machine learning models to predict one or more values of the second field; and
selecting one of the one or more predicted values as the representative value of the second field.

10. The method of claim 1, wherein the KE data model comprises a first plurality of fields having values to be entered by a user, a second plurality of fields to be calculated based on values of other fields of the KE data model, and a third plurality of fields to be predicted using the one or more machine learning models.

11. A computing device associated with one or more machine learning models, the computing device comprising:
one or more processors; and
a memory storing instructions that, when executed by the one or more processors, cause the computing device to perform operations comprising:
identifying a first field in a knowledge engineering (KE) data model which lacks a value and for which one or more machine learning models are defined, the first field being associated with one or more dependent fields;
determining that each of the dependent fields of the first field has a respective value in the KE data model;
executing each of the one or more machine learning models to predict one or more values for the first field;
selecting one of the one or more predicted values as the representative value of the first field;
identifying one or more further fields in the KE data model for which the first field is a dependent field, none of the one or more further fields defining any machine learning models; and
calculating values for each of the one or more further fields based at least in part on the representative value of the first field.

12. The computing device of claim 11, wherein the representative value of the first field is the predicted value associated with a highest priority machine learning model of the one or more machine learning models.

13. The computing device of claim 11, wherein the representative value of the first field is selected based at least in part on respective confidence levels associated with each of the one or more predicted values.

14. The computing device of claim 11, wherein the representative value of the first field is selected based at least in part on a prioritization list associated with the one or more machine learning models and on respective confidence levels associated with each of the one or more predicted values.

15. The computing device of claim 11, wherein execution of the instructions for selecting one of the one or more predicted values as the representative value of the first field causes the computing device to perform operations further comprising discarding a predicted value when a corresponding confidence level of the predicted value is less than a threshold confidence level.

16. The computing device of claim 11, wherein execution of the instructions for entering the selected one of the one or more predicted values as the value of the first field causes the computing device to perform operations further comprising adding the selected one of the predicted values and metadata associated with the selected one of the predicted values to the KE data model.

17. The computing device of claim 17, wherein the metadata indicates at least an indication that the value of the first field was predicted, and a confidence level associated with the selected one of the predicted values.

18. The computing device of claim 11, wherein execution of the instructions causes the computing device to perform operations further comprising identifying one or more incomplete fields of the KE data model for which no value is provided and prompting a user to enter a value for a highest priority field of the one or more incomplete fields.

19. The computing device of claim 18, wherein execution of the instructions causes the computing device to perform operations further comprising, after prompting the user to enter the value for the highest priority field of the determined one or more incomplete fields:
identifying a second field in the KE data model which lacks a value and for which one or more machine learning models are defined;
determining that each dependent field of the second field has a respective value in the KE data model;
executing each of the one or more machine learning models to predict one or more predicted values of the second field; and
selecting one of the one or more predicted values as the representative value of the second field.

20. A non-transitory computer-readable medium storing instructions that, when executed by one or more processors of a computing device, cause the computing device to predict one or more field values using machine learning in a knowledge engineering (KE) data model by performing operations comprising:
identifying a first field in the KE data model which lacks a value and for which one or more machine learning models are defined, the first field being associated with one or more dependent fields;
determining that each dependent fields of the first field has a respective value in the KE data model;
execute each of the one or more machine learning models to predict one or more values for the first field;
selecting one of the one or more predicted values as the representative value of the first field;
identifying one or more further fields in the KE data model for which the first field is a dependent field, none of the one or more further fields defining any machine learning models; and
calculating values for each of the one or more further fields based at least in part on the representative value of the first field.
